(19) United States
(12) Patent Application Publication
(10) Pub. No.: US 2024/0208387 A1
(43) Pub. Date: Jun. 27, 2024

(54) VEHICLE FOOTREST STRUCTURE

(71) Applicants: Hyundai Motor Company, Seoul (KR); Kia Corporation, Seoul (KR)

(72) Inventors: Dong Kyu Kim, Hwaseong-si (KR); Chulhee Heo, Hwaseong-si (KR); Seokju Gim, Seongnam-si (KR)

(21) Appl. No.: 18/475,478

(22) Filed: Sep. 27, 2023

(30) Foreign Application Priority Data
Dec. 22, 2022 (KR) 10-2022-0181493

(51) Int. Cl. B60N 3/06; F16B 5/08

(52) U.S. Cl. CPC B60N 3/06; F16B 5/08

(57) ABSTRACT

An embodiment vehicle footrest includes a body portion extending in a length direction of a vehicle body of a vehicle and configured to come into contact with and support a foot of an occupant in the vehicle, a first fastening portion integrated with the body portion at a front end of the body portion and fastened to a dash portion of the vehicle body, and a second fastening portion fastened to a seat cross member of the vehicle body at a rear end of the body portion.

### CROSS-REFERENCE TO RELATED APPLICATIONS

This application claims the benefit of Korean Patent Application No. 10-2022-0181493, filed on Dec. 22, 2022, which application is hereby incorporated herein by reference.

### TECHNICAL FIELD

The present invention relates to a vehicle footrest structure.

### BACKGROUND

In general, a footrest on which a driver may rest his/her feet is installed inside a vehicle. As illustrated in FIGS. 1A and 1B, in a case of a general passenger car, a footrest 2 is installed on a floor surface 3 of a vehicle body in consideration of dwelling quality for the feet of a driver. The purpose of applying such an existing footrest 2 is to provide convenience by supporting the feet of a driver, and since the footrest 2 has a simple structure, there is no effect of improving performance.

### SUMMARY

The present invention relates to a vehicle footrest structure. Particular embodiments relate to a footrest structure applied to a purpose built vehicle (PBV).

Embodiments of the present disclosure provide a footrest structure capable of providing convenience by supporting the feet of a driver and preventing vehicle deformation by improving crashworthiness.

A vehicle footrest according to an exemplary embodiment of the present invention installed on an inner side of a vehicle body of a vehicle to support a foot of an occupant includes a body portion extending in a length direction of the vehicle body and coming into contact with and supporting the foot of the occupant, a first fastening portion integrated with the body portion at a front end of the body portion and fastened to a dash portion of the vehicle, and a second fastening portion fastened to a seat cross member of the vehicle at a rear end of the body portion.

The first fastening portion may be fastened to a dash cross member of the dash portion.

The first fastening portion may have a bolt hole, and the first fastening portion may be fastened to an upper surface of the dash cross member by inserting a bolt into the bolt hole.

The second fastening portion may be fastened to the seat cross member by welding.

The body portion may be pivotably fastened to the second fastening portion in a state in which the second fastening portion is fixed to the seat cross member.

The second fastening portion may be pivotably coupled to a hinge pin formed at an end of the body portion.

The second fastening portion may be fitted into a hinge hole formed at the end of the body portion.

A reinforcement portion with which the foot of the occupant comes into contact may be formed at a central portion of the body portion.

The second fastening portion may be fastened to the seat cross member by a bolt.

According to an exemplary embodiment of the present invention, vehicle crashworthiness may be improved by installing the footrest across a dash cross member and a seat cross member, which are main members for vehicle crashworthiness.

In addition, integral molding may be applied to form a single component including a body portion and two connection regions at once, so that costs for molds, a weight, and material costs may be reduced, which is advantageous.

Furthermore, as a configuration in which the body portion and the connection region are connected by the hinge structure is applied, it is possible to flexibly cope with different seat heights according to vehicle specifications.

### BRIEF DESCRIPTION OF THE DRAWINGS

FIGS. 1A and 1B are views illustrating a footrest installation state of an existing general passenger car;

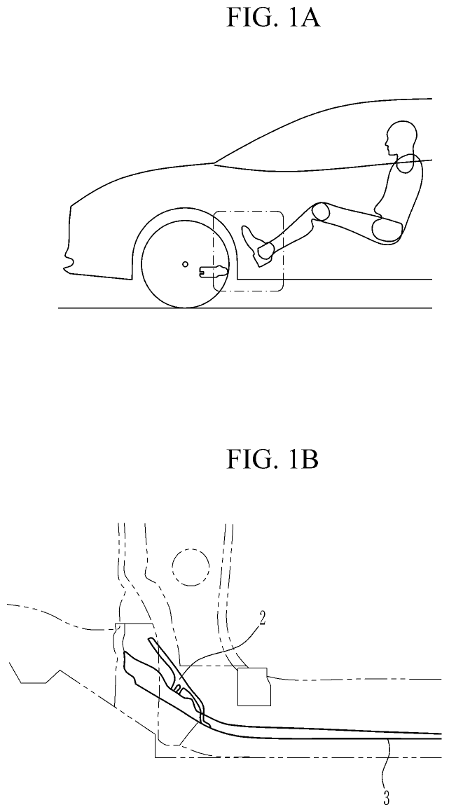

FIG. 2 is a view illustrating a state in which a footrest according to an exemplary embodiment of the present invention is fastened to a dash portion and a seat cross member;

FIG. 3 is a view illustrating the footrest according to an exemplary embodiment of the present invention;

FIGS. 4A and 4B are views illustrating a state in which the footrest according to an exemplary embodiment of the present invention is sequentially fastened to the seat cross member and the dash portion;

FIGS. 5A and 5B are views illustrating a process in which a footrest according to another exemplary embodiment of the present invention is fastened to the dash portion after being fastened to the seat cross member of a center floor; and

FIG. 6 is a view illustrating a state in which a footrest according to still another exemplary embodiment of the present invention is fastened to the seat cross member and the dash portion.

### DETAILED DESCRIPTION OF ILLUSTRATIVE EMBODIMENTS

Hereinafter, exemplary embodiments of the present invention will be described in detail with reference to the accompanying drawings so that those skilled in the art to which the present invention pertains may easily practice embodiments of the present invention. However, the embodiments of the present invention may be implemented in various different forms and are not limited to the exemplary embodiments provided herein.

In addition, in several exemplary embodiments, components having the same configuration will be representatively described using the same reference numerals in an exemplary embodiment, and only components different from those of an exemplary embodiment will be described in the other exemplary embodiments.

It is to be noted that the drawings are schematic and not drawn to scale. Relative dimensions and proportions of portions in the drawings are shown exaggerated or reduced in size for clarity and convenience in the drawings, and any dimensions are illustrative only and not limiting. Further, the same reference numerals are used to indicate similar features in the same structure, element, or part appearing in two or more drawings. When a part is referred to as being “on” another part, it may be directly on the other part or there may be other parts intervening therebetween.

Exemplary embodiments of the present invention will be described in detail. As a result, various modifications of the exemplary embodiments are expected. Therefore, an exemplary embodiment is not limited to a specific aspect of an illustrated region, and for example, includes modifications made for manufacturing.

Hereinafter, a vehicle footrest structure according to exemplary embodiments of the present invention will be described in detail with reference to the accompanying drawings.

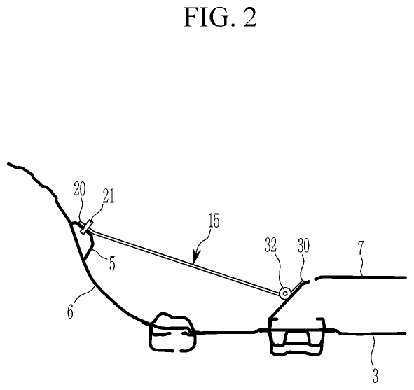

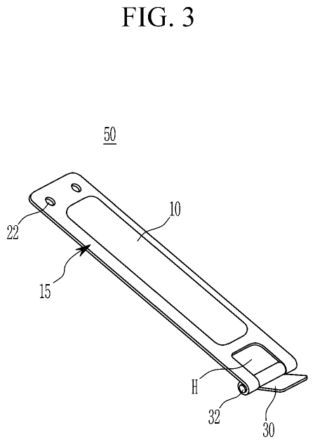

FIG. 2 is a view illustrating a state in which a footrest according to an exemplary embodiment of the present invention is fastened to a dash portion and a seat cross member. FIG. 3 is a view illustrating the footrest according to an exemplary embodiment of the present invention.

Referring to FIGS. 2 and 3, a vehicle footrest 50 according to an exemplary embodiment of the present invention is fastened to an inner side of a vehicle body of a vehicle, that is, a dash portion 6 and a seat cross member 7, to support a foot of an occupant. The footrest 50 includes a body portion 15, a first fastening portion 20, and a second fastening portion 30.

The body portion 15 is a portion that directly comes into contact with the foot of the occupant and extends in a length direction of the vehicle body in a state in which the body portion 15 is fastened across the dash portion 6 and the seat cross member 7. A central portion of the body portion 15, that is, a surface with which the foot of the occupant comes into contact, may include a reinforcement portion 10 formed in a convex shape. Such a shape of the reinforcement portion 10 improves rigidity of the body portion 15 to withstand a load of the foot.

The first fastening portion 20 and the second fastening portion 30 are formed on opposite ends of the body portion 15. The first fastening portion 20 is positioned at a front end of the body portion 15 and may be integrated with the body portion 15. The first fastening portion 20 may be fastened to a dash cross member 5 of the dash portion 6.

The first fastening portion 20 may be fastened to an upper surface of the dash cross member 5 of the dash portion 6 by a bolt 21. To this end, a bolt hole 22 may be provided in the first fastening portion 20, and the bolt 21 may be inserted into the bolt hole 22 to fasten the first fastening portion 20 to the dash cross member 5. Here, a pair of bolt holes 22 may be arranged in a direction perpendicular to a length direction of the body portion 15, and the bolts 21 may be inserted into and coupled to each of the bolt holes 22.

The second fastening portion 30 is positioned on an end opposite to the end on which the first fastening portion 20 is positioned. That is, the second fastening portion 30 is positioned at a rear end of the body portion 15 and may be integrated with the body portion 15. The second fastening portion 30 may be fastened to the seat cross member 7.

The second fastening portion 30 may be fastened to the seat cross member 7 by welding. The second fastening portion 30 may be pivotably coupled to a hinge pin 32 formed at an end of the body portion 15 and may be fitted into a hinge hole H formed at the end of the body portion 15. A front surface portion of the second fastening portion 30 may be welded to an upper surface of the seat cross member 7. Since the second fastening portion 30 may pivot around the hinge pin 32, the body portion 15 may pivot after the second fastening portion 30 is welded to the seat cross member 7.

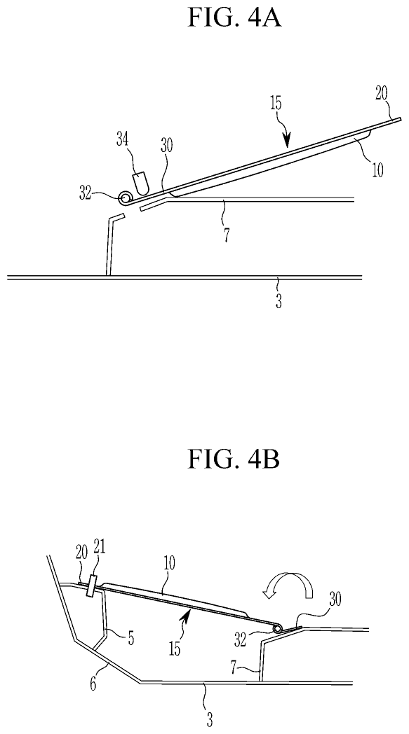

FIGS. 4A and 4B are views illustrating a state in which the footrest according to an exemplary embodiment of the present invention is sequentially fastened to the seat cross member and the dash portion.

Referring to FIGS. 4A and 4B, the second fastening portion 30 of the footrest 50 is fastened to the seat cross member 7 provided on a center floor 3 of the vehicle body by welding using a welding device 34 (a). At this time, the second fastening portion 30 is in a state of being fitted into the hinge hole H, and a surface of the body portion 15 with which the foot of the occupant comes into contact faces the seat cross member 7.

After fastening the second fastening portion 30, the footrest 50 is pivoted around the hinge pin 32, and the first fastening portion 20 is fastened to the dash cross member 5 (b). The first fastening portion 20 may be fastened to the dash cross member 5 by the bolt 21. At this time, the surface of the body portion 15 with which the foot of the occupant comes into contact faces upward, and the footrest 50 is installed between the dash cross member 5 and the seat cross member 7.

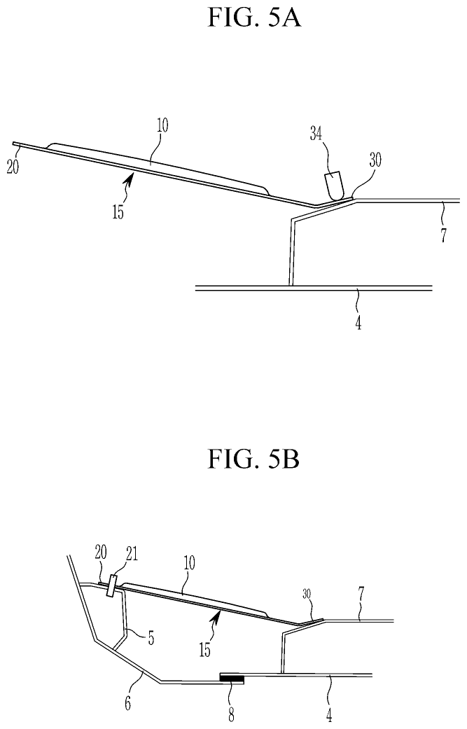

FIGS. 5A and 5B are views illustrating a process in which a footrest according to another exemplary embodiment of the present invention is fastened to the dash portion after being fastened to the seat cross member of the center floor.

Referring to FIGS. 5A and 5B, the footrest 50 is fastened to the seat cross member 7 disposed on a center floor 4, and then, the seat cross member 7 to which the footrest 50 is fastened is coupled to the dash portion 6.

In a separate manufacturing process, the second fastening portion 30 of the footrest 50 is fastened to the seat cross member 7 by welding (a), and the center floor 4 to which the footrest 50 is fastened is loaded in a vehicle body assembly process and then is coupled to the dash portion 6 (b). The center floor 4 and the dash portion 6 may be coupled to each other by a structure adhesive 8 (adhesive tape), and a length of a portion where the center floor 4 and the dash portion 6 are bonded to each other may be about 70 mm. After the center floor 4 and the dash portion 6 are coupled to each other, the first fastening portion 20 of the footrest 50 may be fastened to the dash cross member 5 of the dash portion 6 by the bolt 21. In this way, installation of the footrest 50 between the dash portion 6 and the seat cross member 7 is completed.

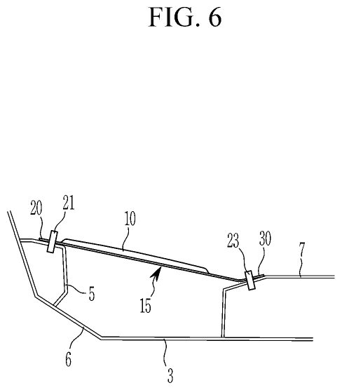

FIG. 6 is a view illustrating a state in which a footrest according to still another exemplary embodiment of the present invention is fastened to the seat cross member and the dash portion.

Referring to FIG. 6, the second fastening portion 30 of the footrest 50 may be fastened to the seat cross member 7 by a bolt 23 rather than by welding. After loading the separately manufactured footrest 50 in a vehicle body assembly process, the footrest 50 is disposed across the dash cross member 5 and the seat cross member 7, and then, the first fastening portion 20 is fastened to the dash cross member 5 by the bolt 21, and the second fastening portion 30 is fastened to the seat cross member 7 by the bolt 23. Similarly to the first fastening portion 20, in the second fastening portion 30, a pair of bolt holes (not illustrated) may be arranged in a direction perpendicular to the length direction, and the bolts 23 may be inserted into and coupled to each of the bolt holes.

As described above, according to an exemplary embodiment of the present invention, the footrest may be installed in consideration of a seat height of an indoor occupant in a purpose built vehicle (PBV) to comfortably support the foot of the occupant.

Vehicle crashworthiness may be improved by installing the footrest across the dash cross member and the seat cross member, which are main members for vehicle crashworthiness.

In addition, integral molding may be applied to form a single component including a body portion and two connection regions at once, so that costs for molds, a weight, and material costs may be reduced, which is advantageous.

Furthermore, as a configuration in which the body portion and the connection region are connected by the hinge structure is applied, it is possible to flexibly cope with different seat heights according to PBV specifications.

While embodiments of the invention have been described in connection with what is presently considered to be practical exemplary embodiments, it is to be understood that the embodiments of the invention are not limited to the disclosed embodiments. On the contrary, they are intended to cover various modifications and equivalent arrangements included within the spirit and scope of the appended claims.

The following reference identifiers may be used in connection with the drawings to describe various features of embodiments of the present invention.

| | |
|---|---|
| 3, 4: center floor | 5: dash cross member |
| 6: dash portion | 7: seat cross member |
| 8: structure adhesive | 10: reinforcement portion |
| 15: body portion | 20: first fastening portion |
| 21, 23: bolt | 22: bolt hole |
| 30: second fastening portion | 32: hinge pin |
| H: hinge hole | |

What is claimed is:

1. A vehicle footrest comprising:
a body portion extending in a length direction of a vehicle body of a vehicle and configured to come into contact with and support a foot of an occupant in the vehicle;
a first fastening portion integrated with the body portion at a front end of the body portion and fastened to a dash portion of the vehicle body; and
a second fastening portion fastened to a seat cross member of the vehicle body at a rear end of the body portion.

2. The vehicle footrest of claim 1, wherein the first fastening portion is fastened to a dash cross member of the dash portion.

3. The vehicle footrest of claim 2, wherein:
the first fastening portion comprises a bolt hole; and
the first fastening portion is fastened to an upper surface of the dash cross member by a bolt inserted into the bolt hole.

4. The vehicle footrest of claim 1, wherein the second fastening portion is fastened to the seat cross member by a weld.

5. The vehicle footrest of claim 4, wherein the body portion is pivotably fastened to the second fastening portion in a state in which the second fastening portion is fixed to the seat cross member.

6. The vehicle footrest of claim 5, wherein the second fastening portion is pivotably coupled to a hinge pin disposed at an end of the body portion.

7. The vehicle footrest of claim 6, wherein the second fastening portion is fitted into a hinge hole disposed at the end of the body portion.

8. The vehicle footrest of claim 1, further comprising a reinforcement portion at a central portion of the body portion, wherein the reinforcement portion is configured to come in contact with the foot of the occupant.

9. The vehicle footrest of claim 1, wherein the second fastening portion is fastened to the seat cross member by a bolt.

10. A vehicle footrest comprising:
a body portion extending in a length direction of a vehicle body of a vehicle and configured to come into contact with and support a foot of an occupant in the vehicle;
a first fastening portion integrated with the body portion at a front end of the body portion and fastened to a dash cross member of a dash portion of the vehicle body; and
a second fastening portion fastened by a weld to a seat cross member of the vehicle body at a rear end of the body portion.

11. The vehicle footrest of claim 10, wherein:
the first fastening portion comprises a bolt hole; and
the first fastening portion is fastened to an upper surface of the dash cross member by a bolt inserted into the bolt hole.

12. The vehicle footrest of claim 11, wherein the body portion is pivotably fastened to the second fastening portion in a state in which the second fastening portion is fixed to the seat cross member.

13. The vehicle footrest of claim 11, wherein the second fastening portion is pivotably coupled to a hinge pin disposed at an end of the body portion.

14. The vehicle footrest of claim 13, wherein the second fastening portion is fitted into a hinge hole disposed at the end of the body portion.

15. The vehicle footrest of claim 10, further comprising a reinforcement portion at a central portion of the body portion, wherein the reinforcement portion is configured to come in contact with the foot of the occupant.

16. A vehicle comprising:
a vehicle body comprising a center floor, a dash portion coupled to the center floor, and a seat cross member on the center floor; and
a footrest installed on an inner side of the vehicle body, the footrest comprising:
a body portion extending in a length direction of the vehicle body;
a reinforcement portion at a central portion of the body portion, wherein the reinforcement portion is configured to come into contact with a foot of an occupant in the vehicle;
a first fastening portion integrated with the body portion at a front end of the body portion and fastened to the dash portion; and
a second fastening portion fastened to the seat cross member at a rear end of the body portion.

17. The vehicle of claim 16, wherein the first fastening portion is fastened to a dash cross member of the dash portion.

18. The vehicle of claim 17, wherein:
the first fastening portion comprises a bolt hole; and
the first fastening portion is fastened to an upper surface of the dash cross member by a bolt inserted into the bolt hole.

19. The vehicle of claim 16, wherein:
the second fastening portion is fastened to the seat cross member by a weld; and
the body portion is pivotably fastened to the second fastening portion in a state in which the second fastening portion is fixed to the seat cross member;
the second fastening portion is pivotably coupled to a hinge pin disposed at an end of the body portion; and
the second fastening portion is fitted into a hinge hole disposed at the end of the body portion.

20. The vehicle of claim 16, wherein the second fastening portion is fastened to the seat cross member by a bolt.
